(19) United States
(12) Patent Application Publication
(10) Pub. No.: US 2002/0147680 A1
(43) Pub. Date: Oct. 10, 2002

(54) Rent collection and payment system

(76) Inventors: Yong Sa Cho, Hempstead, NY (US); Nichiei Ryu, Meguro-ku (JP)

Correspondence Address: BROWN, RAYSMAN, MILLSTEIN, FELDER & STEINER LLP, 900 THIRD AVENUE, NEW YORK, NY, 10022, US

(21) Appl. No.: 09/828,503

(22) Filed: Apr. 6, 2001

(51) Int. Cl. G06F 17/60

(52) U.S. Cl. 705/40; 705/39; 705/42

(57) ABSTRACT

A rent collection and payment system, where an intermediary collects rent from a tenant and pays the rent less a commission to a landlord. The intermediary is obligated to pay the landlord at a predetermined schedule, irrespective of the timing of the receipt of rent from the tenant. However, if the tenant fails to pay the rent due for one or more predetermined periods, the intermediary's obligation to pay the landlord will cease. This rent collection and payment system provides the landlord with a more stable cash flow and also provides the tenant with additional flexibility in paying rent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention relates to the field of commerce, and more particularly to a method of normalizing the cash flow of rental payments to landlords.

Tenants often pay rent by way of a personal check sent by mail to landlords. This common method frequently poses problems for landlords. Landlords may not receive the rent from tenants on time for a variety of reasons, including innocent forgetfulness or the fact that at least some tenants have insufficient funds in their bank accounts. Landlords often require stable, reliable cash flow in order to pay their necessary expenses, such as mortgage payments and the cost of maintenance and upkeep. Regardless of whether the rent was paid by the tenants on time, landlords are required to pay these expenses on time and in the absence thereof will incur costs or losses such as interest charges on late payments, late payment penalties or lost opportunity costs. Thus, late payments by tenants directly affect the landlords' profitability.

Tenants are also inconvenienced by this method due to its inflexibility. Tenants must ensure that their bank account has a sufficient balance and also must ensure that the rent payment check is delivered in time. Sometimes tenants just forget to prepare personal checks on time due to the ever-increasing demands of every day life. In other circumstances a tenant's income flow, while in aggregate sufficient to cover the annual rent, may nonetheless be irregular. Students are a good example of this. Late payments by tenants inconvenience landlords for the aforementioned reasons and often create conflict or friction between the landlord and tenant. While a variety of electronic payment systems exist, none appear to address the need for flexibility in and reliability of rent payments

### SUMMARY OF THE INVENTION

The invention provides landlords with a more stable cash flow arising out of the rental of their property whilst increasing the flexibility in which tenants can pay their rent. According to one aspect of the invention, a rent collection and payment method and system is provided where an intermediary collects rent from a tenant and pays the rent to a landlord. The intermediary is obligated to pay the landlord at a predetermined schedule, irrespective of the timing of the receipt of the rent from the tenant. However, if the tenant fails to pay the rent due for one or more predetermined periods, the intermediary's obligation to pay the landlord will cease. The intermediary preferably charges a commission to at least one of the landlord and tenant for this service.

According to another aspect of the invention, a rent collection and payment system is provided which includes automated means for collecting, or at least attempting to collect, a rental payment from a financial account associated with a tenant. Payment means are provided for paying an amount equivalent to the rental payment less a commission to a financial account associated with the landlord, wherein said amount is paid to the landlord at a pre-determined schedule irrespective of the timing of receipt of the rental payment from the tenant. The rent collection and payment system is preferably controlled by an intermediary who profits (or loses) from the commissions charged. The intermediary preferably makes the rental payment to the landlord unless the intermediary is unable to collect the rent from the tenant for a pre-determined time period(s), e.g., two successive months, in which case the intermediary's guarantee to the landlord ceases. The system is programmed accordingly.

In the preferred embodiment the intermediary enters into separate agreements with the landlord and the tenant. Under the terms of the agreements, the intermediary agrees to collect rent from the tenant on behalf of the landlord and pay the landlord the rent less a commission at regular intervals. The intermediary will pay the landlord the rent less a commission at regular intervals regardless of whether or when the tenant paid the intermediary, unless the intermediary had failed to pay the intermediary the required rent payment for a pre-determined period of time, e.g., two successive months. In addition, the tenant is able to pay rent late to the intermediary subject to a late fee, so long as the tenant pays all rent and late fees due within the pre-determined time period. The intermediary does not notify the landlord of a failure on the part of the tenant to pay rent, unless the tenant fails to pay the rent and late fee within a specified grace period. This method has the effect of normalizing the cash flow to the landlord in cases where the tenant is not overly delinquent. The tenant also has additional flexibility in paying the rent because the tenant has the ability to pay rent late, subject to late fees and a grace period. Furthermore, the tenant can pay rent late without the landlord knowing that the tenant was late, so long as the rent and late fee is paid to the intermediary within the grace period.

These and other attributes of the present invention will become apparent to those skilled in the art when viewed in light of the accompanying drawings and following detailed description.

### BRIEF DESCRIPTION OF THE DRAWINGS

The method is illustrated in the figures of the accompanying drawings which are meant to be exemplary and not limiting, in which like references are intended to refer to like or corresponding parts, and in which:

FIG. 1 is an overview of a method carried out by a rent collection and payment system according to the preferred embodiment; and

FIG. 2 is a flowchart illustrating one step of the rent collection and payment system in greater detail.

### DETAILED DESCRIPTION OF PREFERRED EMBODIMENTS

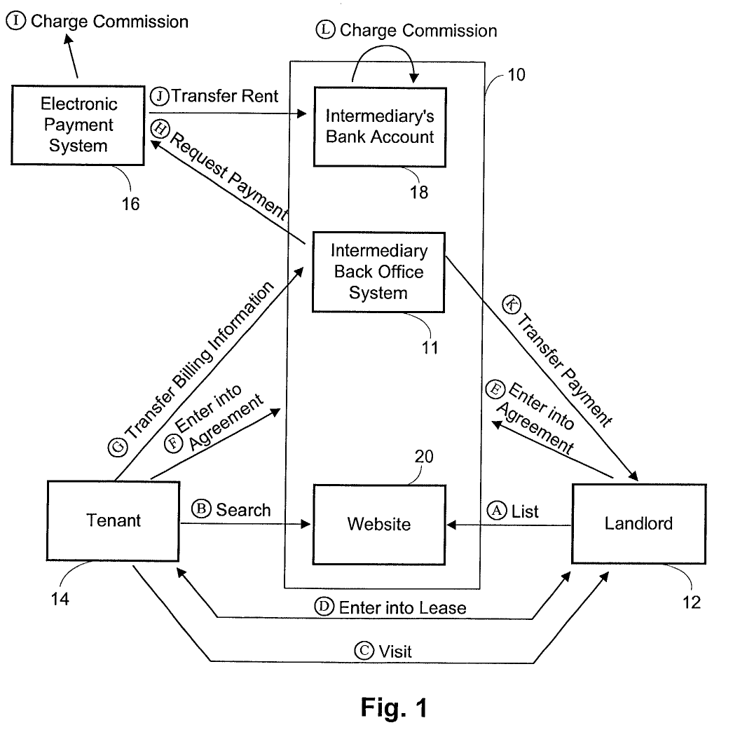

FIG. 1 shows a method inherent in a rent collection and payment system according the preferred embodiment of the invention. An intermediary 10 establishes a web site 20, wherein a landlord 12 can submit descriptions of real estate property for rent as well as the term of the lease, required rent and, if desired, any other pertinent information about the rental property. The intermediary lists the descriptions on the web site 10, step A, enabling a tenant 14 to view and search for satisfactory real estate property listed on the web site 20, step B. After the tenant 14 is satisfied with the property, e.g., by arranging for a personal visit, step C, the tenant 14 and landlord 12 enter into a lease arrangement for the rental of the landlord's real estate property, step D. The lease agreement may be entered into in the traditional paper-based manner or, if desired, the lease agreement may be made available on the web site 10 and entered into electronically. The landlord 12 preferably receives a security deposit for the rent and/or potential damages directly from the tenant 14 before the intermediary 10 is engaged to collect rent on behalf of the landlord, as described in greater detail below. However, in alternative embodiments the intermediary 10 may be empowered to collect the security deposit on behalf of or instead of the landlord 12.

Next, the landlord 12 enters into an agreement, step E, with the intermediary 10, whereby the intermediary agrees to collect rent from the tenant 14 on behalf of the landlord 12. Under the agreement, the intermediary will pay rent to the landlord at a predetermined schedule, irrespective of the timing of the receipt of rent payment from the tenant 12. However, if the tenant fails to pay the rent due for a pre-determined time period(s) and any late fees levied against the tenant, the intermediary's guarantee and obligation to pay the landlord will cease. In return, the intermediary retains or withholds a commission from the rent that is collected. The agreement specifies the amount of rent to be collected, the schedule under which the rent is to be paid and the commission that will be retained or withheld by the intermediary. The landlord and intermediary also agree that in the event that the intermediary's collection of the rent plus late fees is unsuccessful for a pre-determined period of time, e.g., two successive or consecutive months, the agreement will expire under its terms.

The intermediary 10 also enters into a second agreement, step F, with the tenant 14 whereby the tenant agrees to pay the monthly rent to the intermediary according to the predetermined schedule set forth in the landlord-intermediary agreement. The tenant also agrees that in the event that the tenant is unable to pay the rent to the intermediary, the tenant will owe a late fee to the intermediary in addition to the rent due for every month that the rent is not paid on time. The intermediary agrees to pay the landlord rent on behalf of the tenant according to the predetermined schedule so long as the tenant does not fail to pay to the intermediary all rent and late fees due for a predetermined time period, e.g., two successive or consecutive months. The second agreement specifies the late fee and grace period, as well as billing information for the collection of rent. This information can be in the form of the tenant's credit card information or bank and debit card number to which the intermediary will directly charge the monthly rent. The transfer of billing information is shown as step G in FIG. 1.

Templates of the intermediary-landlord agreement and intermediary-tenant agreement are preferably posted on the web site 10 as forms which can be filled in by the landlord and tenant. The forms preferably have input fields to capture the relevant information from the landlord and tenant. These fields may capture information such as: the landlord's name, the landlord's address, the amount of rent due, the dates on which the intermediary must make the payments, the tenant's name, tenant's address, references of the tenant, and financial account information of the tenant and landlord for billing and payment purposes. If desired, a tri-lateral agreement can be established between the parties.

Prior to entering into the agreement with the tenant and landlord, the intermediary will preferably execute a credit check on the tenant. This can be carried out manually, or, since the tenant has provided the relevant information electronically to the web site, more preferably through an automated credit check with a credit reporting agency as known in the art per se. Where the tenant is a student, the intermediary may alternatively make the credit-granting decision based on confirmation of enrollment with a university or the like.

After the agreements are executed, the intermediary will preferably employ its “back office” system 11 (shown coextensive with block 10 representing the intermediary) to automatically charge the tenant's bank account or credit account utilizing the services of known debit or credit payment systems 16 according to the schedule agreed upon between the tenant and the intermediary. The request is shown as step H in FIG. 1. The proprietor of the payment system may charge a commission for this service, step I, following which the rent is transferred to the intermediary's bank account 18. Alternatively, the tenant may send a personal check to the intermediary. These steps are described in greater detail below, but a brief description follows. In the event that the collection from the tenant is unsuccessful, the intermediary assesses a late fee against the tenant. The tenant will then owe the late fee to the intermediary in addition to the monthly rent. The landlord will not be informed of the tenant's delinquency in paying the rent unless the monthly rent and the late fee is not collected by the intermediary within a pre-determined grace period. The tenant and intermediary also agree that in the event that the intermediary's collection of the rent plus late fees is unsuccessful for a predetermined time period, e.g., two successive months, the agreement will expire under its terms. The tenant also agrees that the intermediary will retain the right to collect from the tenant any rent and late fees due after the second agreement terminates.

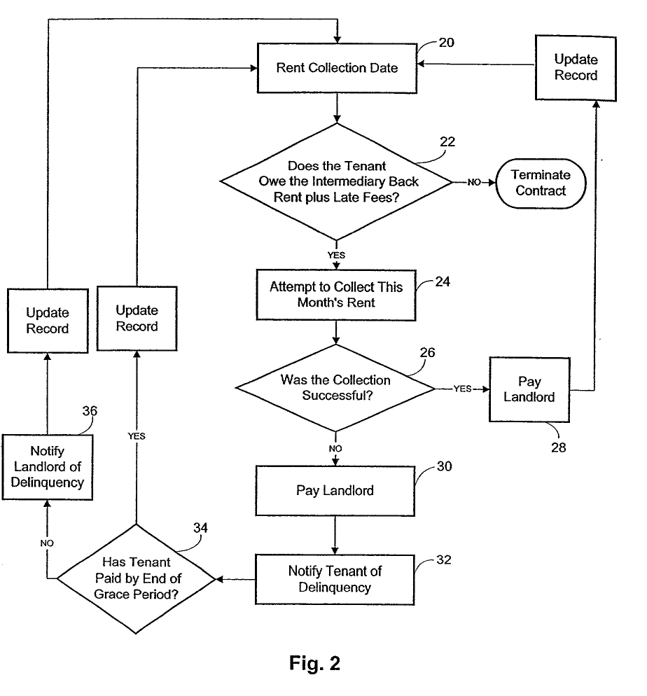

The intermediary pays the landlord, step K, according to the schedule agreed upon therebetween, unless the intermediary's obligations terminated due to the failure to collect the rent and late fees from the tenant as previously described. The payment is equal to the rent less a commission withheld by the intermediary, step L. The steps of determining whether the intermediary will pay the landlord are described in greater detail below with reference to FIG. 2. The payment can be made to the landlord according to the method agreed upon in the agreement between the intermediary and landlord. These methods include mailing a corporate check to the landlord and depositing the amount (electronically or otherwise) directly into the landlord's account, based on the information provided by the landlord.

The system provides advantages to both tenant and landlord. The tenant is afforded greater flexibility in paying the rent because of the intermediary's guaranteed payment to the landlord. This flexibility can be further increased or leveraged if the tenant provides the intermediary with credit card information. The landlord is guaranteed a timely cash flow and, at least for a pre-determined period of time, the hassles of collecting late rent payments which can be more effectively accomplished by the intermediary due to economies of scale.

FIG. 2 further describes the process in which the intermediary collects rent from the tenant, pays the rent to the landlord less a commission and informs the landlord of the tenant's delinquency, if any. The intermediary's back office system 11 maintains a database in which records of the tenant's payment history is kept. The back office system determines a rent collection date under the predetermined schedule as set forth in the agreements, step 20, and then querys the database to determine whether the tenant was required to pay back rent plus late fees and failed to do so, step 22. If the tenant failed to do so, the intermediary's obligations will terminate and the back office system 11 notifies the parties accordingly, e.g., via e-mail and/or prepared printed correspondence.

If the tenant does not currently owe the intermediary back rent plus late fees, the back office system 11 attempts to collect rent from the tenant using the account(s) specified in the intermediary-tenant agreement, step 24. The back office system 11 determines whether the collection is successful, step 26. If the collection is successful, the back office system 11 arranges to pay the landlord, step 30, the predetermined amount agreed upon between the intermediary and landlord and updates the tenant's record in the database to reflect that the tenant has paid rent for that month. The back office system preferably utilizes the services of known debit payment systems or prints a corporate check for subsequent mailing. The process repeats until the next date set forth in the predetermined schedule, unless the most recent date of collection was the last date in the schedule, in which case both agreements will terminate.

If the collection is not successful, the intermediary will nonetheless pay the landlord the predetermined amount agreed upon, step 30. The intermediary will then notify the tenant, using e-mail, postal mail, telephone or otherwise, of the tenant's delinquency in payment, step 32. The intermediary will then wait for a specified grace period set forth in the intermediary-tenant agreement to allow the tenant to pay the overdue rent and late fee. The back office system then determines whether the tenant has paid the intermediary the rent payment plus the late fee, step 34. Specifically, this can be done by i) receiving a personal check from the tenant for the rent payment and late fee, or ii) receiving notification from the client of a credit card account or debit card account that has sufficient funds, followed by a successful collection by the intermediary of the amount due from said account. If the tenant has paid the intermediary by this time, the back office system 11 updates the tenant's information in the database to reflect that no outstanding payments are due. The process repeats itself until the next date set forth in the predetermined schedule, unless the most recent date of collection was the last date in the schedule, in which case both agreements will terminate.

If the tenant has not paid the intermediary before the end of the grace period, the intermediary will inform the landlord of the tenant's delinquency in payment, step 36. The back office system 11 will update the tenant's information in the database to reflect that the tenant has an outstanding payment due for the rent and the late fee. The process will repeat until the next date set forth in the predetermined schedule, unless the most recent date of collection was the last date in the schedule, in which case both agreements will terminate.

While the invention has been described and illustrated in connection with preferred embodiments, many variations and modifications as will be evident to those skilled in this art may be made without departing from the spirit and scope of the invention. For example, while mention has been made herein that the intermediary charges or receives its commission from the landlord, the commission could be charged to the tenant. Similarly, the back office system can be fully automated or many processes thereof can be implemented manually. The invention should not be limited to the precise details of methodology or construction set forth above as such variations and modification are intended to be included within the spirit and scope of the invention.

What is claimed is:

1. A method of intermediating between a landlord and a tenant, comprising:
collecting or attempting to collect consideration from the tenant for renting the landlord's real estate property;
paying the landlord a predetermined amount for the rental at a predetermined schedule, irrespective of the receipt of consideration from tenant; and
charging the tenant or landlord a commission for said collection and said payment.

2. The method according to claim 1, wherein the step of paying the landlord ceases in the event insufficient consideration is collected from the tenant for one or more predetermined time periods.

3. The method according to claim 1, wherein the step of accepting consideration from the tenant comprises charging a credit card account of the tenant.

4. The method according to claim 1, wherein the step of accepting consideration from the tenant comprises debiting a bank account of the tenant.

5. The method according to claim 1, wherein the step of paying the landlord comprises mailing a corporate check of the predetermined amount to the landlord.

6. The method according to claim 1, wherein the step of paying the landlord comprises a wire transfer of the predetermined amount into a bank account of the landlord.

7. A method of intermediating between a landlord and a tenant, comprising:
collecting or attempting to collect a rental payment from the tenant by an intermediary for the tenant's rental real estate property from the landlord;
said intermediary paying the landlord an amount equivalent to the rental payment less a commission, said amount being paid at a predetermined schedule, irrespective of the timing of receipt of the rental payment from the tenant.

8. The method according to claim 7, wherein the step of paying the landlord ceases in the event insufficient consideration is collected from the tenant for one or more predetermined time periods.

9. The method according to claim 7, wherein the step of attempting to obtain the predetermined amount of money comprises charging a credit card account of the tenant.

10. The method according to claim 7, wherein the step of attempting to obtain the predetermined amount of money comprises charging a bank account of the tenant.

11. The method according to claim 7, wherein the step of paying the landlord comprises mailing a corporate check of the predetermined amount to the landlord.

12. The method according to claim 7, wherein the step of paying the landlord comprises a wire transfer of the predetermined amount into a bank account of the landlord.

13. A rent collection and payment system, comprising:
automated means for collecting or attempting to collect a rental payment from a financial account associated with a tenant for the tenant's rental of real estate property from a landlord;
payment means for paying an amount equivalent to the rental payment less a commission to a financial account associated with the landlord, wherein said amount is paid to the landlord at a predetermined schedule irrespective of the timing of receipt of the rental payment from the tenant.

14. The system according to claim 13, including means for ceasing to pay the landlord in the event insufficient rent payment is received from the tenant's account for a predetermined period of time.
